(19) United States
(12) Patent Application Publication
(10) Pub. No.: US 2008/0143749 A1
(43) Pub. Date: Jun. 19, 2008

(54) Post-Render Graphics Rotation

(75) Inventors: Steven Todd Weybrew, Portland, OR (US); Simon Wilson, Dacono, CO (US); Brian Ellis, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/955,218

(22) Filed: Dec. 12, 2007

Related U.S. Application Data
(60) Provisional application No. 60/870,356, filed on Dec. 15, 2006.

(51) Int. Cl. G09G 5/00

(52) U.S. Cl. 345/649

(57) ABSTRACT

An apparatus, method, and computer program product for rotating a rendered surface. The apparatus includes a graphics processor configured to render a surface, wherein a display orientation parameter is associated with the surface, the display orientation parameter defining a rotation process. The apparatus further includes a display processor configured to rotate the rendered surface in accordance with the display orientation parameter. Preferably, the display orientation parameter is an EGL surface attribute.

### RELATED APPLICATIONS

This application claims the benefit of provisional U.S. Application Ser. No. 60/870,356 filed Dec. 15, 2006, which is incorporated by reference herein.

### TECHNICAL FIELD

This disclosure relates to graphics processing, and more particularly, relates to the rotation of graphics surfaces after a rendering process.

### BACKGROUND

Mobile devices, including cell phones, portable multimedia devices, and portable video gaming devices, exhibit vastly different display sizes and orientations. In addition, some mobile device displays are easily oriented in many directions. In contrast, desktop and laptop displays are typically in a landscape orientation. Since many user applications are originally written for desktop and laptop use, the display orientation that such applications are designed for is often different than that which is available and/or capable in mobile devices. Modifying user applications, in particular 3D applications, to support both landscape and portrait displays is time-consuming and expensive because it generally involves modification of both code and art assets.

In general, 3D user applications are programmed for the “default” orientation of the device display screen. In some cases, 3D applications have included code to allow the user to select alternative orientations. These modifications result in larger application size and may involve additional art assets which require additional filesystem space on the mobile device. As resources on mobile devices are often limited, increases in system resources to support graphics processes are often unacceptable.

### SUMMARY

In view of the foregoing, this disclosure presents methods, apparatuses, and computer program products that enable an application to allow the surface rendered by a graphics processing unit (GPU) to be rotated as desired for use in a mobile device display with minimal changes to the code of the application. Additionally, an external “preferences” application could determine the applied rotation (and other potential post-rendering processes, such as scaling) applied to active 3D applications thus eliminating any code changes within the user applications themselves.

According to one embodiment, the apparatus includes a graphics processor configured to render a surface, wherein a display orientation parameter is associated with the surface, the display orientation parameter defining a rotation process. The apparatus further includes a display processor configured to rotate the rendered surface in accordance with the display orientation parameter. Preferably, the display orientation parameter is an EGL surface attribute.

The details of one or more embodiments are set forth in the accompanying drawings and the description below. Other features, objects, and advantages of the invention will be apparent from the description and drawings, and from the claims.

### BRIEF DESCRIPTION OF DRAWINGS

FIG. 1. is a block diagram of a GPU and a display processor.

FIG. 2 is a flowchart of a method for rotating a surface.

FIG. 3 is a block diagram of a GPU and a display processor in a mobile device.

FIG. 4 is a flowchart of a method for rotating a surface.

FIG. 5 shows attributes for an EGL surface including rotation parameters.

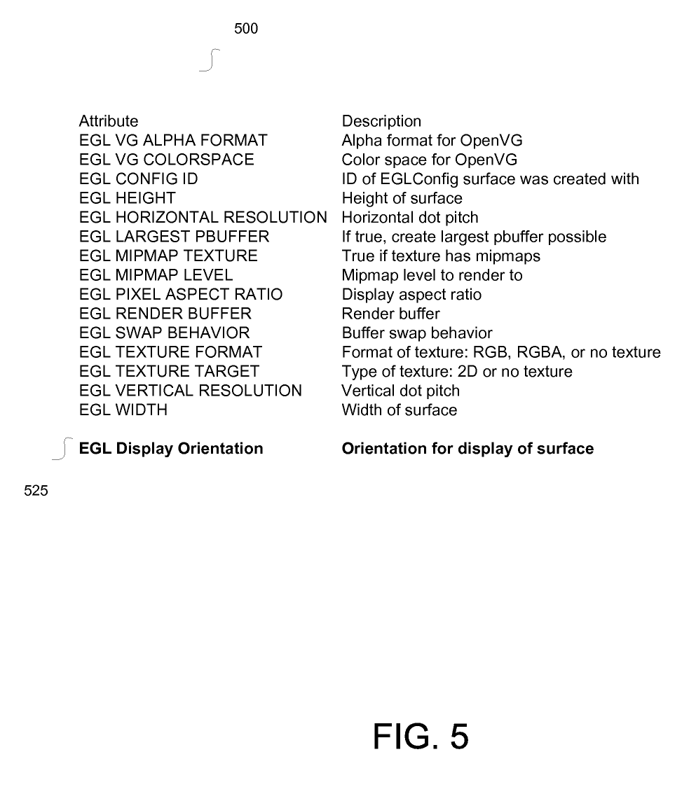

### DETAILED DESCRIPTION

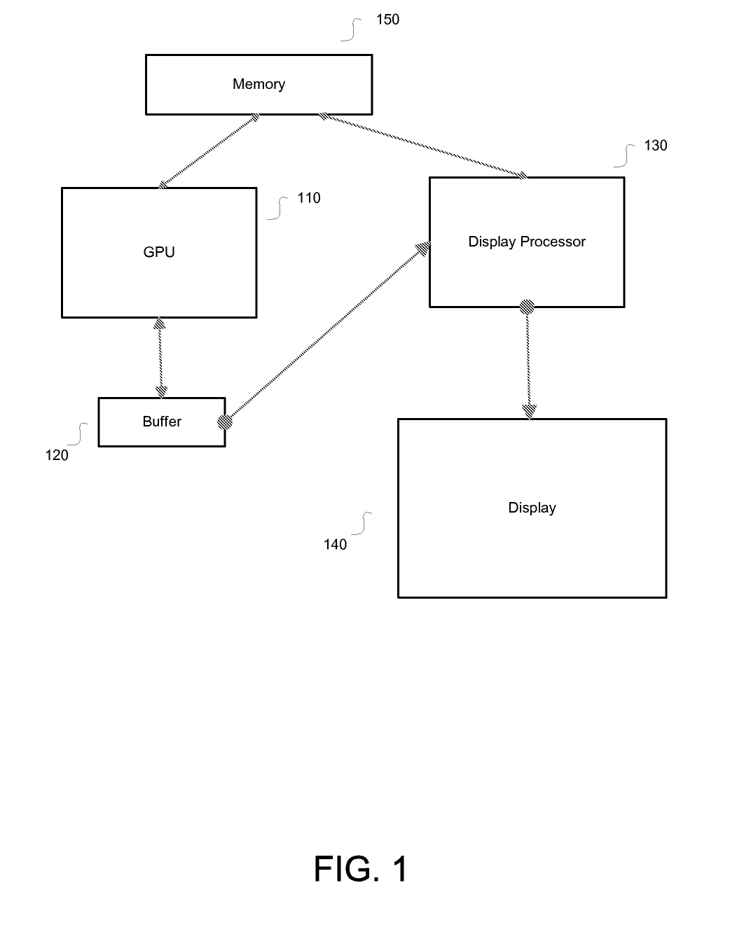

FIG. 1 shows a block diagram of a GPU and a display processor. A graphics processing unit (GPU) is a dedicated graphics rendering device utilized to render, manipulate and display computerized graphics. GPUs are typically built with a highly parallel structure that provides more efficient processing than typical, general purpose central processing units (CPUs) for a range of complex graphics-related algorithms. For example, the complex algorithms may correspond to representations of three-dimensional computerized graphics. A GPU may implement a number of so-called “primitive” graphics operations, such as forming points, lines, and triangles, to create complex, three-dimensional images on a display more quickly than drawing the images directly to the display with a CPU.

GPU 110 is a graphics processor used for rendering a graphics frame for eventual display. For this disclosure, the term render refers to both 3D and 2D rendering. As examples, GPU 110 may utilize Open Graphics Library (OpenGL) instructions to render 3D graphics frames, or may utilize Open Vector Graphics (OpenVG) instructions to render 2D graphics frames. However, any standards, methods, or techniques for rendering graphics may be utilized by GPU 110.

GPU 110 may carry out instructions that are stored in memory 150. Memory 150 may include any permanent or volatile memory capable of storing instructions. In addition, GPU 110 may execute instructions that are received over an air interface (e.g., CDMA 1x, EV-DO, WiFi). Graphics frames rendered by GPU 110 are stored in buffer 120.

In this context, a graphics frame is the entire scene that is to be displayed. A graphics frame may be made up of one or more surfaces that may be individually rendered by GPU 110. A surface is either a 2-D image or a rendered 2-D representation of a 3-D object from a certain viewpoint. Multiple rendered surfaces that are displayed in the graphics frame may be combined through overlay and/or blending operations.

Buffer 120 may be any permanent or volatile memory capable of storing data. The surface rendered by GPU 110 is rendered at some predetermined orientation. Typically, 3D user programs render to a landscape orientation. However, any orientation to which a 3D user application renders is acceptable. A desired display orientation is determined. For example, a user program utilizing the GPU may determine a desired display orientation based on the needs of the user program, characteristics of the display (i.e., possible orientations for the display), current display or device orientation, or user input. Additionally, the display orientation may be determined outside of the user program based on the current orientation of the display or device and/or user input. The selected value of the display orientation is stored in memory 150 for use by display processor 130.

In particular, the display orientation may be stored as a parameter associated with a surface that is to be rendered and displayed. As one example, this parameter may be an attribute included in an Embedded-System Graphics Library (EGL™) description of the surface. EGL is an interface between APIs such as OpenGL ES or OpenVG and an underlying native platform window system. In this way, third-party developers of applications may define a display orientation using a familiar programming language without having to develop separate commands for instructing a particular display processor to perform a rotation process. FIG. 8 shows an example of EGL surface attributes 500 including the display orientation 525 rotation parameter.

Display processor 130 is a processor for driving display 140 (i.e., sending the pixel color values to the display), and for performing post-rendering processes on the rendered surface. Display processor 130 may be any type of processor. As one example, display processor 130 may be a Mobile Display Processor (MDP) embedded in Mobile Station Modems designed by Qualcomm, Inc. of San Diego, Calif. An MDP is a processor that has been dedicated to and optimized for driving a display and performing post-render functions on a rendered surface. Such functions may include scaling, rotation, blending, color keying, and overlaying. Display processor 130 may be constructed to execute instructions stored in memory 150.

When GPU 110 has rendered a surface and stored it in buffer 120, display processor 130 retrieves the rendered surface from buffer 120 and rotates the rendered surface to the selected orientation. The orientation may be obtained from memory 150 or may be predetermined based on the characteristics of display 140. By using a different processor for rotation, processing overhead is saved for the GPU. In addition, expensive and time consuming code changes in user programs as well as multiple sets of art assets are avoided.

The rendered surface may be rotated to any angle desired. However, typical rotations for switching between orientations (e.g., landscape to portrait) employ rotations in integer multiples of 90 degrees. Discrete rotations of 90, 180, and 270 may be accomplished through various combinations of three base operations: 90 degree rotation, horizontal flip, and vertical flip. As such, in many applications it would be beneficial to limit the orientation selection to the selection of individual or combined selections of 90 degree rotation, horizontal flip, and vertical flip commands. In this way, the number of instructions employed for selecting an orientation, and thus commanding a rotation, are limited. This may save memory and processing bandwidth as well as silicon area and power in some scenarios. Such rotation may be combined with a scaling process to prevent letterboxing of the rotated surface. This means few to no modifications to the OpenGL code or the art assets of a user application are required.

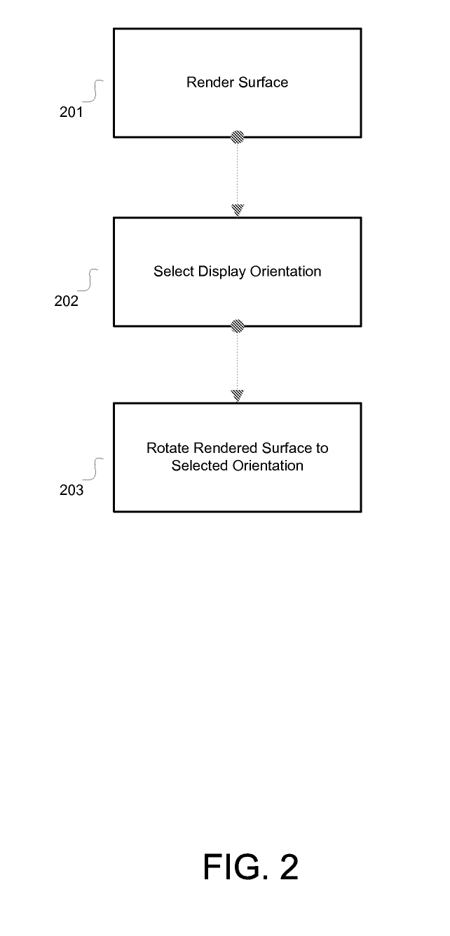

FIG. 2 is a flowchart of a method for rotating a surface. In step 201, a surface is rendered. In step 202, a display orientation is selected. Then in step 203, the rendered surface is rotated to the selected orientation.

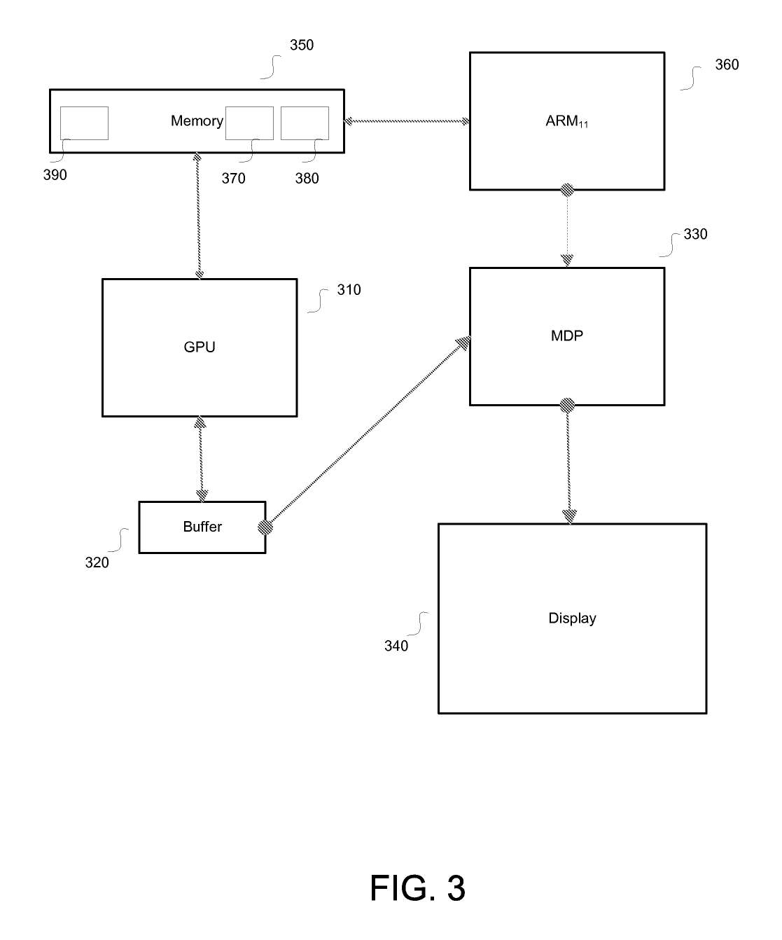

FIG. 3 is a block diagram of a GPU and a display processor in a mobile device. GPU 310 executes instructions from user program 390 stored in memory 350. As an example, GPU 310 may be an Imageon 7 series GPU made by Advanced Micro Devices, Inc. of Sunnyvale, Calif. Memory 350 may be implemented as Flash random access memory (RAM). User program 390 may be any program that utilizes GPU 310. For example, user program 390 may be a video game. GPU 310 executes instructions from user program 390 and renders surfaces to be displayed into buffer 320. Buffer 320 may be in synchronous dynamic RAM (SDRAM). User program 390 may be configured to establish connection to display 340 and/or determine system parameters in order to determine an orientation at which to display the rendered surface. Such system parameters may be stored in memory 350. Once the display orientation has been selected by user program 390, user program 390 stores this orientation as control parameters 370 in memory 350. As mentioned above, the selected orientation may be stored in control parameters 370 as individual or combined selections of 90 degree rotate, horizontal flip, and vertical flip commands.

Memory 350 may also be used to store Application Programming Interface (API) 380. API 380 serves as the conduit between user program 390 and MDP 330. When GPU 310 has rendered a surface to buffer 320, user program 390 may execute an instruction to display that surface. Such a display instruction may be a function that calls API 380. API 380 then instructs control processor 360 to control MDP 330 to rotate the rendered surface in buffer 320 to the selected orientation stored as control parameters 370. Control processor 360 may be an Advanced RISC (reduced instruction set computer) Machine (ARM) processor such as the ARM₁₁ processor embedded in Mobile Station Modems designed by Qualcomm, Inc. of San Diego, Calif. MDP 330 may be a mobile display processor embedded in Mobile Station Modems designed by Qualcomm, Inc. of San Diego, Calif. MDP 330 retrieves the rendered surface from buffer 320, rotates the rendered surface to the desired orientation, and drives display 340 to display the rotated rendered surface.

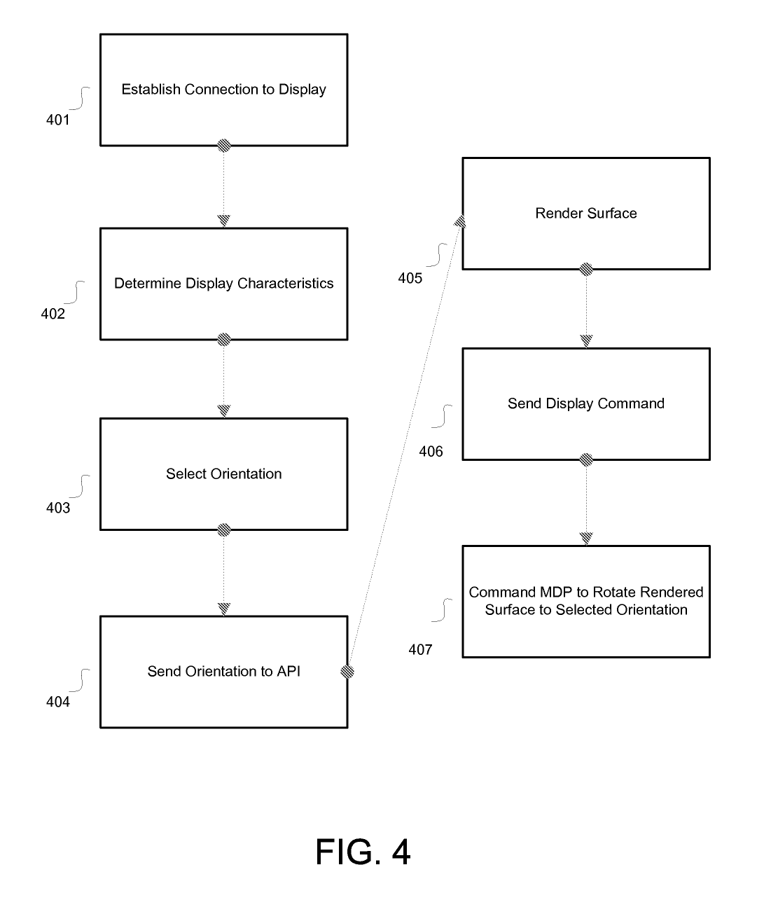

FIG. 4 is a flowchart of a method for rotating a surface. In step 401, a connection to a display is established. Then in step 402, the characteristics of the display are determined. Such characteristics may be determined from data previously stored in memory, or through direct communication with the display. In step 403, a display orientation is selected. In step 404, the selected orientation is sent to or made available to an API. In step 405, a surface is rendered. In step 406, a display command (e.g., eglSwapBuffers) is sent to the API. In step 407, the API sends a command to the MDP to rotate the rendered surface to the selected orientation.

The apparatuses, methods, and computer program products described above may be employed by various types of devices, such as a wireless phone, a cellular phone, a laptop computer, a wireless multimedia device (e.g., a portable video player or portable video gaming device), a wireless communication personal computer (PC) card, a personal digital assistant (PDA), an external or internal modem, or any device that communicates through a wireless channel.

Such devices may have various names, such as access terminal (AT), access unit, subscriber unit, mobile station, mobile device, mobile unit, mobile phone, mobile, remote station, remote terminal, remote unit, user device, user equipment, handheld device, etc.

Any device described above may have a dedicated memory for storing instructions and data, as well as dedicated hardware, software, firmware, or combinations thereof. If implemented in software, the techniques may be embodied as instructions on a computer-readable medium, such as random access memory (RAM), read-only memory (ROM), non-volatile random access memory (NVRAM), electrically erasable programmable read-only memory (EEPROM), FLASH memory, magnetic or optical data storage device, or the like, executable by one or more processors. The instructions cause one or more processors to perform certain aspects of the functionality described in this disclosure.

The techniques described in this disclosure may be implemented within a general purpose microprocessor, digital signal processor (DSP), application specific integrated circuit (ASIC), field programmable gate array (FPGA), or other equivalent logic devices. Accordingly, components described as modules may form programmable features of such a process, or a separate process.

Various embodiments described herein may be combined in whole or in part. These and other embodiments are within the scope of the following claims.

1. An apparatus for processing graphics comprising:
a graphics processor configured to render a surface, wherein a display orientation parameter is associated with the surface, the display orientation parameter defining a rotation process; and
a display processor configured to rotate the rendered surface in accordance with the display orientation parameter.

2. The apparatus of claim 1, where in the display orientation parameter is an EGL surface attribute.

3. The apparatus of claim 1, wherein the display orientation parameter is defined by a 90 degree rotation, a horizontal flip, and a vertical flip.

4. The apparatus of claim 1, further including:
a memory configured to store the display orientation parameter; and
a control processor configured to instruct the display processor to rotate the rendered surface in accordance with the display orientation parameter.

5. An apparatus for processing graphics comprising:
means for rendering a surface, wherein a display orientation parameter is associated with the surface, the display orientation parameter defining a rotation process; and
rotating means for rotating the rendered surface in accordance with the display orientation parameter.

6. The apparatus of claim 5, where in the display orientation parameter is an EGL surface attribute.

7. The apparatus of claim 5, wherein the display orientation parameter is defined by a 90 degree rotation, a horizontal flip, and a vertical flip.

8. The apparatus of claim 5, further including:
means for storing the display orientation parameter; and
means for instructing the rotating means to rotate the rendered surface in accordance with the display orientation parameter.

9. A method for rotating a rendered surface comprising:
rendering a surface;
selecting a display orientation; and
rotating the rendered surface to the destination resolution.

10. The method of claim 9, wherein the selected display orientation is associated with the surface through EGL surface attributes.

11. The method of claim 9, wherein the display orientation parameter is defined by a 90 degree rotation, a horizontal flip, and a vertical flip.

12. The method of claim 9, further including:
establishing a connection to a display;
determining display characteristics;
sending the display orientation to an API;
sending a display command; and
sending a command instructing a display processor to perform the rotating step.

13. A computer-readable medium storing computer-executable instructions for rotating a rendered surface, the computer-executable instructions comprising:
code for causing a computer to render a surface;
code for causing a computer to select a display orientation; and
code for causing a computer to rotate the rendered surface to the destination resolution.

14. The computer-readable medium of claim 13, wherein the selected display orientation is associated with the surface through EGL surface attributes.

15. The computer-readable medium of claim 13, wherein the display orientation parameter is defined by a 90 degree rotation, a horizontal flip, and a vertical flip.

16. The computer-readable medium of claim 13, further including:
code for causing a computer to establish a connection to a display;
code for causing a computer to determine display characteristics;
code for causing a computer to send the display orientation to an API;
code for causing a computer to send a display command; and
code for causing a computer to send a command instructing a display processor to perform the rotating step.
